(19) United States
(12) Patent Application Publication
(10) Pub. No.: US 2007/0267790 A1
(43) Pub. Date: Nov. 22, 2007

(54) GOLF CAR SLIDING REAR LEAF SPRING

(75) Inventors: Christopher K. Furman, Augusta, GA (US); Michael J. Hebert, Evans, GA (US); Mark J. Holloway, Evans, GA (US)

Correspondence Address: HARNESS, DICKEY & PIERCE, P.L.C., P.O. BOX 828, BLOOMFIELD HILLS, MI, 48303, US

(73) Assignee: Textron Inc., Providence, RI (US)

(21) Appl. No.: 11/419,404

(22) Filed: May 19, 2006

(51) Int. Cl. B60G 11/02

(52) U.S. Cl. 267/36.1; 267/158

(57) ABSTRACT

A leaf spring assembly for a golf car includes a homogenous spring body having a rolled first end, a curving portion extending away from the rolled first end, a flat portion defining a second end, and a bend portion connecting the curving portion to the flat portion. A pin inserted through the rolled first end rotatably connects the rolled first end to a frame member of the golf car. A U-shaped bracket also connected to the frame member slidably supports the flat portion within the bracket permitting vertical deflections of the leaf spring body to be converted to fore-aft deflections of the flat portion.

### FIELD

The present disclosure relates to devices and methods for using leaf spring assemblies, for example, in golf car and off-road utility vehicles.

### BACKGROUND

The statements in this section merely provide background information related to the present disclosure and may not constitute prior art.

Golf cars and many off-road or utility vehicles commonly have rigid or single axle suspension systems for both the front steerable wheels and the rear driving wheels. Rear suspensions for these vehicles are most commonly leaf springs and/or coiled springs used to support the solid axle. One drawback is this design can provide a stiffer ride feel for the occupants and can also result in reduced control of the golf car over rough terrain and when turning at higher speeds. Some golf car designs have therefore utilized leaf spring and shock absorber combinations to both stabilize the vehicle and to provide a more comfortable ride. The leaf springs are used to promote side-to-side and bounce stability of the suspension. Shock absorbers dampen the leaf spring travel and frequency which therefore promote a more stable and comfortable ride feel.

Leaf spring assemblies commonly include multiple leaf plates which must be frictionally joined by clamp elements or fasteners, which increase the complexity and costs of the assemblies. Leaf spring assemblies are commonly connected to a frame of the golf car using a rolled first end pinned to the frame. A rolled second end is then linked using several link members and several fasteners or pins to the frame. This type of connection requires multiple fasteners which increases installation time and costs, and deflection of the leaf spring is limited by the lengths of the various link members.

### SUMMARY

According to several embodiments of the present disclosure, a leaf spring for a golf car includes a homogenous body. The body includes a rolled first end; a curving portion extending away from the rolled first end; a flat portion defining a second end; and a bend portion connecting the curving portion to the flat portion.

In several embodiments, a leaf spring assembly for a golf car includes a homogenous spring body having a rolled first end, a curving portion extending away from the rolled first end, a flat portion defining a second end, and a bend portion connecting the curving portion to the flat portion. A pin inserted through the rolled first end rotatably connects the rolled first end to a frame member of the golf car. A U-shaped bracket also connected to the frame member slidably supports the flat portion within the bracket permitting vertical deflections of the leaf spring body to be converted to fore-aft deflections of the flat portion.

According to still other embodiments, a golf car includes a frame. A suspension system is connected to the frame. The suspension system includes a leaf spring having a rolled first end rotatably pinned to the frame and a second flat end. A U-shaped bracket is connected to the frame having the second flat end of the leaf spring slidably disposed through the U-shaped bracket. A polymeric bearing element is connected to the U-shaped bracket and is slidably engaged with the flat end. A pin inserted through the U-shaped bracket retains the flat end between the opposed walls and the polymeric bearing element.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a perspective view of a golf car having the rear suspension eyelet mount shocks according to various embodiments;

FIG. 2 is a bottom plan view of the golf car of FIG. 1;

FIG. 3 is a rear elevation view looking forward of the golf car of FIG. 1;

FIG. 4 is a perspective view of a golf car frame having the sliding rear leaf spring assemblies of the present disclosure;

FIG. 5 is a partial rear perspective view of a sliding rear leaf spring assembly of the present disclosure;

FIG. 6 is a perspective view of a sliding rear leaf spring of the present disclosure;

FIG. 7 is an exploded view taken at area 7 of FIG. 3;

FIG. 8 is a side elevational view of the sliding rear leaf spring assembly of FIG. 5; and

FIG. 9 is a rear elevational view looking forward of the sliding rear leaf spring assembly of FIG. 5.

### DETAILED DESCRIPTION

The following description is merely exemplary in nature and is in no way intended to limit the present disclosure, application, or uses. Throughout this specification, like reference numerals will be used to refer to like elements. As referred to herein, the term “golf car” is synonymously used to describe application of the present disclosure to golf cars as well as sport utility vehicles such as modified golf cars, used for example as food and/or beverage cars, golf cars adapted for use as hunting/sporting clays vehicles, golf course maintenance vehicles, and the like.

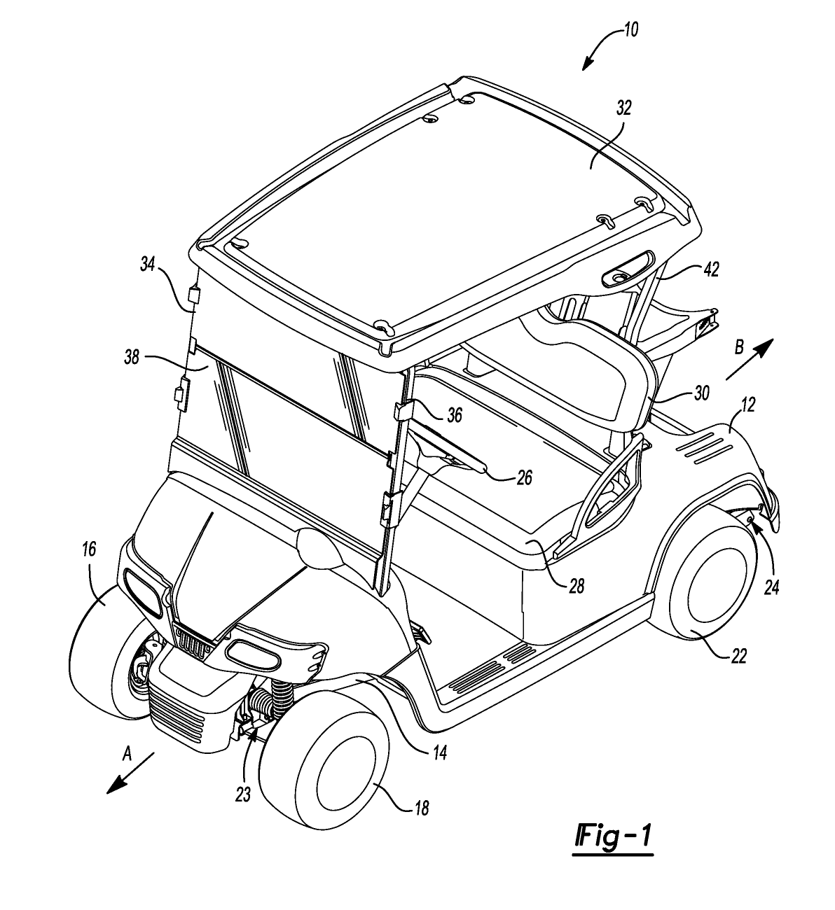

Referring generally to FIG. 1, a golf car 10 can include a body 12 supported from a structural frame 14. Frame 14 can also support a plurality of wheels including a first steerable wheel 16 and a second steerable wheel 18. In addition, powered or driven wheels including a first driven wheel 20 and a second driven wheel 22 are commonly connected to a rear structural portion of frame 14. A front suspension system 23 can also be provided which is adapted for supporting each of the first and second steerable wheels 16, 18. A rear suspension system 24 can also be provided which is adapted for supporting each of the first and second driven wheels 20, 22. A steering mechanism 26 which commonly includes a steering wheel and a support post assembly is also included to provide the necessary steering input to first and second steerable wheels 16, 18.

Golf car 10 can also include a passenger bench seat 28 and a passenger back support cushion 30. A cover or roof 32 can also be provided which is supported from either body 12 or frame 14 by first and second support members 34, 36. A windscreen or windshield 38 can also provided which is also supported by each of first and second support members 34, 36. A rear section of roof 32 can be supported by each of a first and a second rear support elements 40, 42. Other items provided with golf car 10 include golf bag support equipment, accessory racks or bins, headlights, side rails, fenders, and the like.

Golf car 10 is commonly propelled by a power unit such as an engine or battery/motor system which is commonly provided below and/or behind bench seat 28. Golf car 10 is capable of motion in either of a forward direction “A” or a rearward direction “B”. Each of first and second driven wheels 20, 22 can be commonly supported to frame 14 using rear suspension system 24. Each of first and second steerable wheels 16, 18 can be independently or commonly supported to frame 14, therefore the present disclosure is not limited by the design of front suspension system 23.

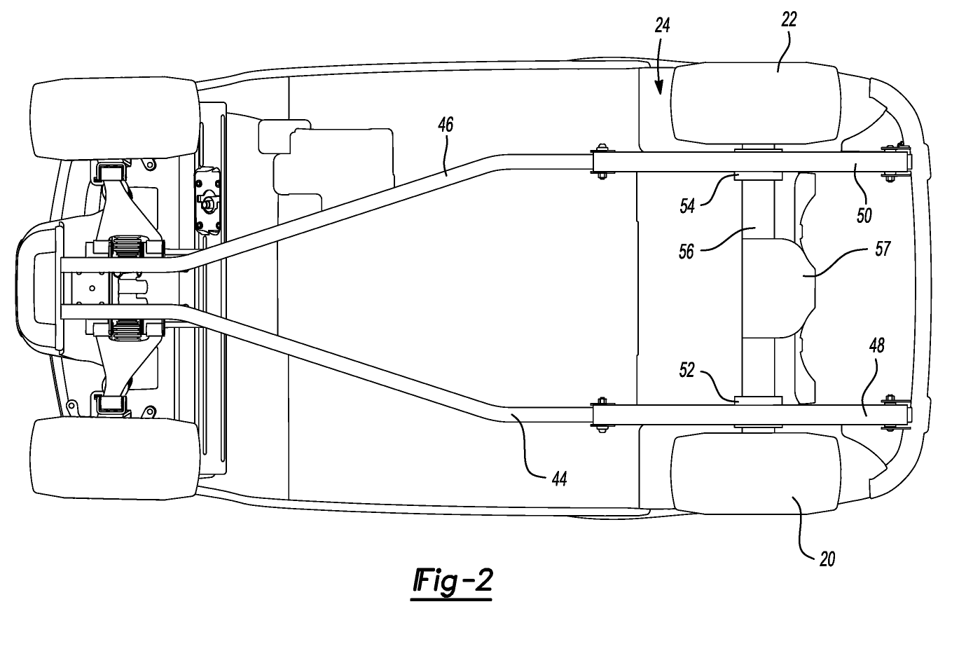

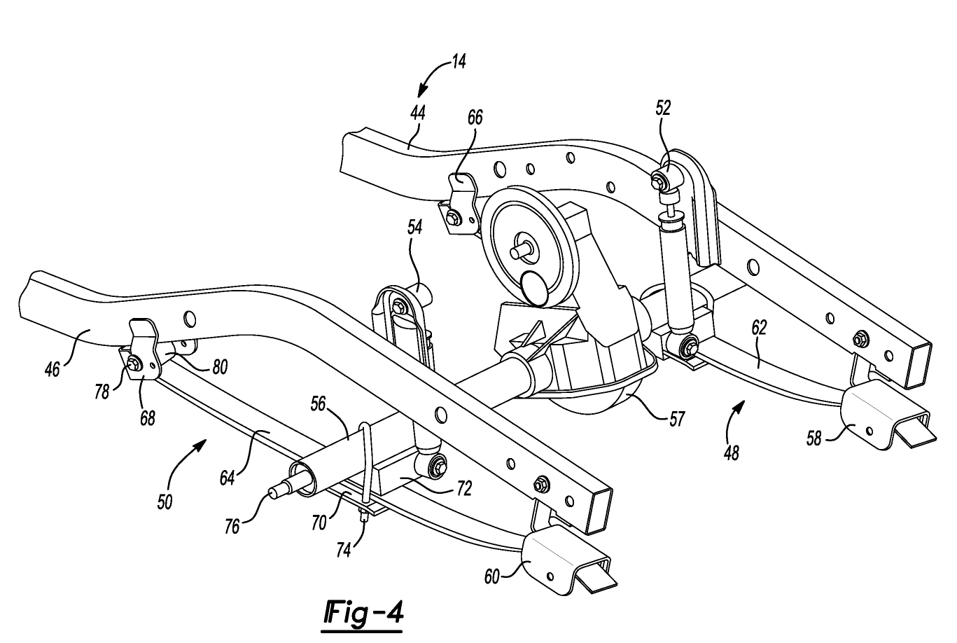

As best seen in reference to FIG. 2, frame 14 can further include a longitudinally arranged first frame member 44 and a second frame member 46. First and second frame members 44, 46 can be hollow, tubular shaped members which are created of a steel material or similar structural material and formed by welding, extruding, hydroforming, or similar processes. A first and second sliding leaf spring assembly 48, 50 support each of first and second driven wheels 20, 22. A first shock assembly 52 can be connected to a first sliding leaf spring assembly 48 and first frame member 44. Similarly, a second shock assembly 54 can be connected to a second sliding leaf spring assembly 50 and second frame member 46. Each of first and second shock assemblies 52, 54 are also connected to an axle housing 56 within which an axle (shown in FIG. 4) is rotatably disposed for providing driving power to the first and second driven wheels 20, 22 through a gear train housed by axle gearhousing 57 connected to the power unit.

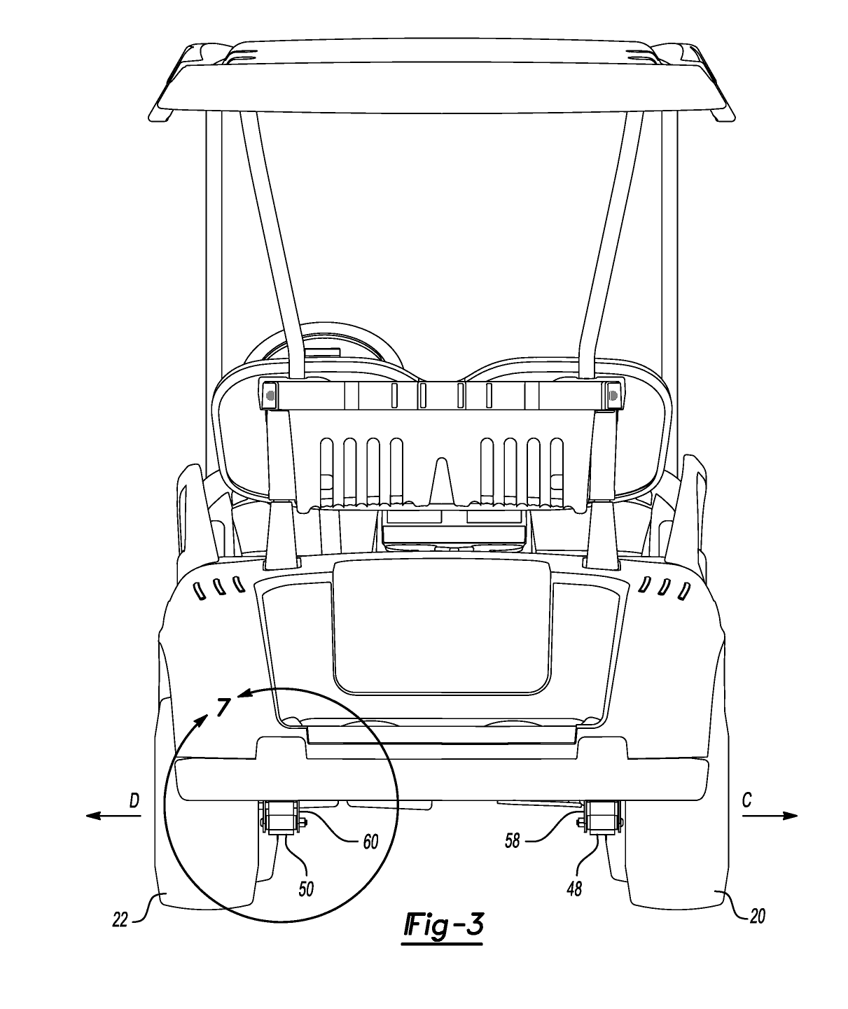

Referring now to FIG. 3, a first sliding leaf bracket assembly 58 connects a rear portion of first sliding leaf spring assembly 48 to frame 14. Similarly, a second sliding leaf bracket assembly 60 connects a rear portion of second sliding leaf spring assembly 50 to frame 14. First and second sliding leaf spring assemblies 48, 50 and first and second sliding leaf bracket assemblies 58, 60 reduce side-to-side deflection of first and second driven wheels 20, 22 in first and second deflection directions “C” and “D” while permitting vertical deflection of the driven wheels with respect to frame 14.

Referring now to FIG. 4, frame 14 includes one of first and second sliding leaf bracket assemblies 58, 60 fastenably connected to a rear end of a corresponding one of first and second frame members 44, 46. First sliding leaf bracket assembly 58 includes a first leaf spring 62. Similarly, second sliding leaf bracket assembly 60 includes a second leaf spring 64. A forward end of first leaf spring 62 is connected to first frame member 44 using a first forward spring bracket 66. Similarly, a forward end of second leaf spring 64 is connected to second frame member 46 using a second forward spring bracket 68. Each of first and second forward spring brackets 66, 68 can be welded to frame 14.

Items that are common to each of first and second sliding leaf bracket assemblies 58 and 60 will be further discussed in reference to second sliding leaf bracket assembly 60. A support plate 70 is suspended below second leaf spring 64, sandwiching second leaf spring 64 between support plate 70 and a shock mount bracket 72. Shock mount bracket 72 is welded or otherwise permanently connected to axle housing 56. Shock mount bracket 72 also acts as a receiving member for a lower end of a shock absorber provided with second shock assembly 54. A sandwiched connection is formed between support plate 70, second leaf spring 64, and shock mount bracket 72 using a U-bolt 74 and fasteners such as nuts. An axle 76 is rotatably disposed within and extends outwardly from opposed ends of axle housing 56, and is connected to both first and second driven wheels 20, 22. Axle housing 56 is positioned between second leaf spring 64 and second frame member 46 with sufficient clearance for vertical motion of axle housing 56. The forward facing end of second leaf spring 64 is connected to second forward spring bracket 68 using a fastener 78 slidably disposed through a rolled end 80 of second leaf spring 64. Fastener 78 permits a rotation of second leaf spring 64 within rolled end 80 during deflection of second leaf spring 64.

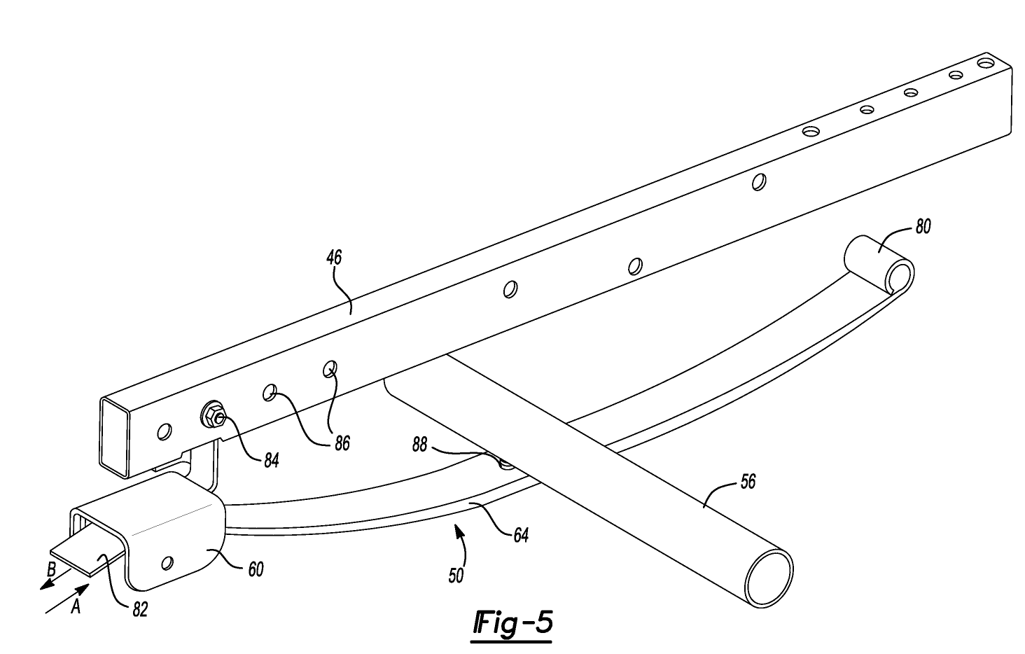

As best seen in reference to FIG. 5, a sliding end 82 of second leaf spring 64 extends rearwardly of second sliding leaf bracket assembly 60. Second sliding leaf bracket assembly 60 is fastened to second frame member 46 using a fastener 84 inserted through an oppositely aligned pair of apertures 86 created through opposed walls of second frame member 46. The plurality of apertures 86 therefore permits varying a length of the leaf springs of the present disclosure. When positioned within second sliding leaf bracket assembly 60 as shown, the sliding end 82 of second leaf spring 64 can slidably displace in either of the forward direction “A” or the rearward direction “B” as second leaf spring 64 deflects either upwardly or downwardly relative to second frame member 46. The use of sliding end 82 therefore eliminates the need for a linked connection at either end of the leaf springs. A locating pin 88 is inserted through second leaf spring 64 in a position which can engage support plate 70. Locating pin 88 fixes the position of second leaf spring 64 relative to axle housing 56 to translate the up and down motion of axle housing 56 and second leaf spring 64 into the fore-aft sliding directions of sliding end 82. The rolled end 80 common to each of first and second leaf springs 62, 64 is created, for example, by rolling a distal end of the leaf spring over a form or by bending in a bending die. The inner diameter of rolled end 80 is sized to accommodate fastener 78 with clearance to permit rolled end 80 to rotate with respect to fastener 78.

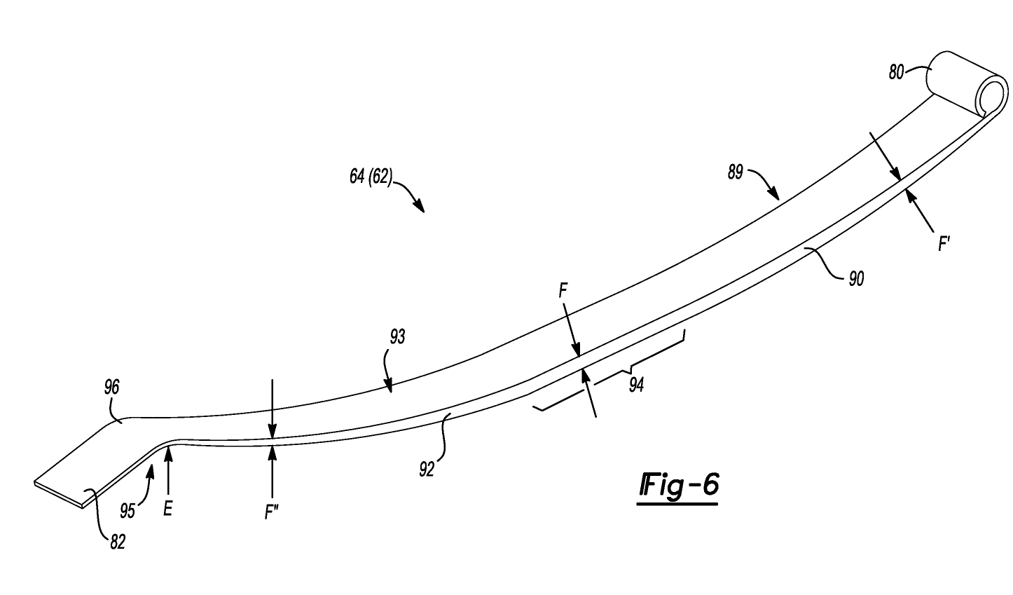

Referring now to FIG. 6, details that are common to each of first and second leaf springs 62, 64 include a homogenous spring body 89 having a first curving portion 90 positioned proximate to the first end or rolled end 80 and a second curving portion 92 extending away from the first curving portion 90 with respect to rolled end 80. A first concavely curved surface 93 is defined by first and second curving portions 90, 92. A planar section 94 can be positioned between first and second curving portions 90, 92. Planar section 94 provides an engagement surface for support plate 70. Extending distally away from second curving portion 92 is a bend portion 96 having a bend radius “E”. A second end of the body 89 defined as sliding end 82 provides a flat portion positioned distally off bend portion 96 with respect to rolled end 80. Sliding end 82 is substantially flat, similar to planar section 94. A second concavely curved surface 95 is defined by bend portion 96. In some embodiments, first concavely curved surface 93 faces opposite to second concavely curved surface 95. A thickness “F” of both first and second leaf springs 62, 64 can be substantially equivalent throughout a length of the leaf spring or can vary in either or both of the first and second curving portions 90, 92 as well as in planar section 94. In some embodiments, a thickness F′ of the first curving portion 90 continuously decreases from the planar section 94 towards the rolled end 80. In several embodiments, a thickness F″ of the second curving portion 92 continuously decreases from the planar section 94 towards the flat portion or sliding end 82.

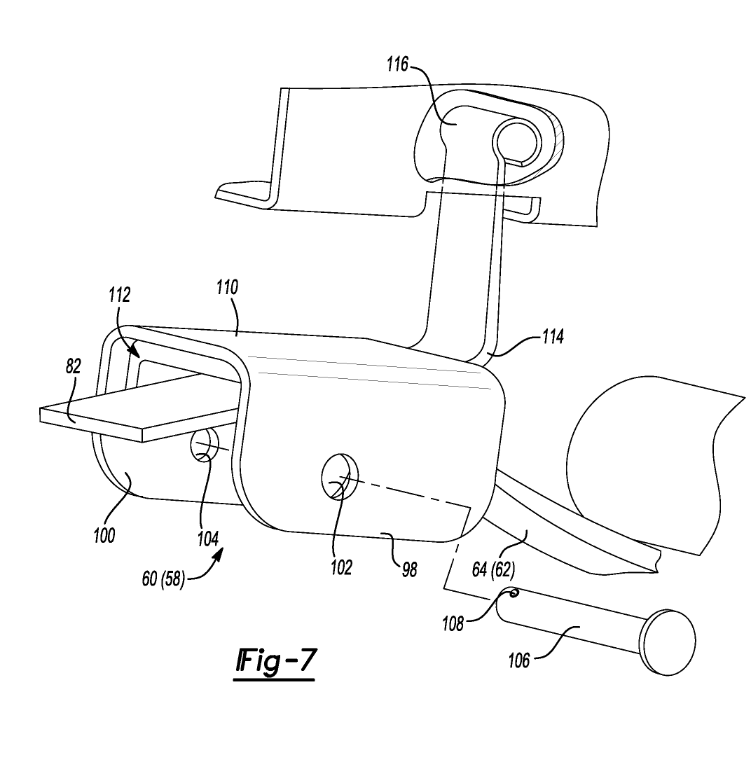

Referring now generally to FIG. 7, details of first and second sliding leaf bracket assemblies 58, 60 that are common to each other include first and second side walls 98, 100. First side wall 98 includes a first clearance aperture 102, and second side wall 100 includes a second clearance aperture 104. First and second clearance apertures 102, 104 are coaxially aligned with each other to receive a pin 106 positioned below sliding end 82 to support either first or second leaf spring 62, 64. Pin 106 includes a retention element aperture 108 for receiving a retention element (not shown) such as a cotter pin or removable/releasable fastener to retain pin 106 in first and second clearance apertures 102, 104. A connecting flange 110 joins each of first and second side walls 98, 100. A substantially U-shaped bearing element 112 is positioned below connecting flange 110 and above sliding end 82. U-shaped bearing element 112 can be created from a polymeric material such as polyamide or DELRIN®, available from the E.I. du Pont de Nemours and Company, which reduces or minimizes the sliding friction of sliding end 82. U-shaped bearing element 112 can be retained within connecting flange 110 by multiple connection devices, such as fasteners, adhesives and the like. In addition to providing clearance for front to back sliding motion of sliding end 82, U-shaped bearing element 112 and pin 106 provide a maximum upward and downward deflection position for sliding end 82. Pin 106 further prevents release of either first or second leaf spring 62, 64 if golf car 10 is lifted to perform maintenance.

Each of first and second sliding leaf bracket assemblies 58, 60 also include a support arm 114 extending from connecting flange 110 either as an integrally created part or a permanently connected part such as by welding. Support arm 114 extends upwardly to a rolled end 116. Rolled end 116 is formed similar to rolled end 80 of each of the first and second leaf springs 62, 64. Fastener 84, shown in FIG. 5, is inserted through one of the first or second frame members 44, 46 to rotatably engage rolled end 116. Some rotation of rolled end 116 and therefore some rotation of each of first and/or second sliding leaf bracket assemblies 58, 60 is permitted by rotation about rolled end 116 in a forward or rearward direction as first or second leaf springs 62, 64 deflect. In some embodiments, rolled end 116 can be fixed, thereby preventing rotation.

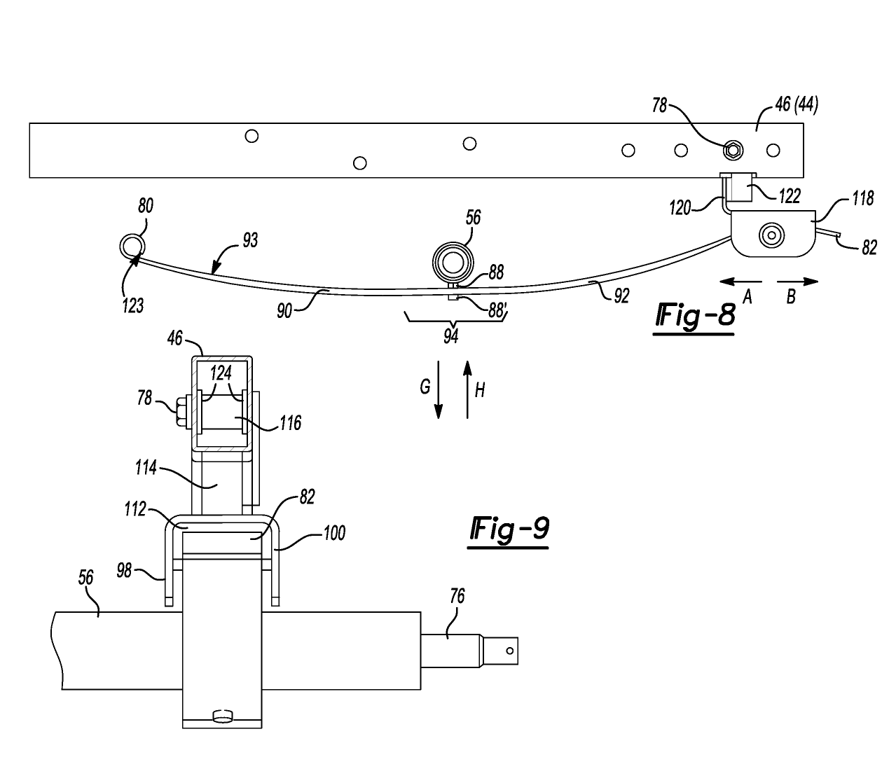

Referring now to FIG. 8, in several embodiments, a sliding bracket assembly 118 similar to first and second sliding leaf bracket assemblies 58, 60 is supported from either first or second frame member 44, 46 by a support arm 120 and a joining member 122. Joining member 122 provides additional stiffness for support arm 120 allowing further extension in a downward direction for sliding bracket assembly 118. Sliding bracket assembly 118 otherwise supports either first or second leaf spring 62, 64 for forward or rearward direction deflection of sliding end 82.

Axle housing 56 is connected to first or second leaf spring 62, 64 at planar section 94. An upward or downward motion of axle housing 56 creates either a downward deflection direction “G” or an upward deflection direction “H” of first or second leaf spring 62, 64 which is permitted by deflection of either or both first and second curving portions 90, 92. Locating pin 88 is also clearly seen in this view having an extending end 88′ with a diameter sized to slidably mate within an aperture of support plate 70. In some embodiments, a distal face 123 of the rolled end 80 is positioned proximate to and faces the first concavely curved surface 93.

Referring now to FIG. 9, a side-to-side clearance between sliding end 82 and U-shaped bearing element 112 is minimized to reduce or eliminate the side-to-side deflection of first or second leaf springs 62, 64. The clearance between rolled end 116 and the inner walls of either first or second frame member 44, 46 is also reduced or minimized to further prevent side-to-side deflection of first or second sliding leaf bracket assembly 58, 60. Bushings 124 can also be positioned between rolled end 116 and the inner walls of first and second frame members 44, 46. Material for bushings 124 can be similar to the material of U-shaped bearing element 112, selected to reduce friction between the moving and/or rotating parts. Except for U-shaped bearing element 112 and bushings 124, the materials of both first and second sliding leaf bracket assemblies 58, 60 are substantially created from a steel material such as a 1010 low carbon steel. The steel material can also be coated to reduce corrosion. Coating can be applied for example by plating and/or by spray such as a powder coating.

The description herein is merely exemplary in nature and, thus, variations that do not depart from the gist of that which is described are intended to be within the scope of the disclosure. Such variations are not to be regarded as a departure from the spirit and scope of the disclosure.

What is claimed is:

1. A leaf spring for a golf car, comprising:
a homogenous body including:
a rolled first end;
a curving portion extending away from the rolled first end;
a flat portion defining a second end; and
a bend portion connecting the curving portion to the flat portion.

2. The leaf spring of claim 1, wherein the curving portion further comprises:
a first curved portion proximate the rolled first end; and
a second curved portion between the first curved portion and the flat portion.

3. The leaf spring of claim 2, further comprising a planar section positioned between the first and second curved portions.

4. The leaf spring of claim 3, wherein a thickness of the first curved portion continuously decreases from the planar section toward the rolled first end.

5. The leaf spring of claim 3, wherein a thickness of the second curved portion continuously decreases from the planar section toward the flat portion.

6. The leaf spring of claim 1, further comprising:
a first concavely curved surface defined by the curving portion; and
a second concavely curved surface defined by the bend portion, the first concavely curved surface facing opposite to the second concavely curved surface.

7. The leaf spring of claim 6, wherein a distal face of the rolled end is positioned proximate to and faces the first concavely curved surface.

8. A leaf spring assembly for a golf car, comprising:
a homogenous spring body including:
a rolled first end;
a curving portion extending away from the rolled first end;
a flat portion defining a second end; and
a bend portion connecting the curving portion to the flat portion; and
a substantially U-shaped bracket having the flat portion slidably disposed within the bracket.

9. The assembly of claim 8, wherein the U-shaped bracket further comprises:
opposed first and second walls outwardly bounding the flat portion;
a connecting flange connecting the first and second opposed walls; and
a support arm integrally connected to the connecting flange.

10. The assembly of claim 9, wherein the U-shaped bracket further comprises:
a first aperture created in the first wall; and
a second aperture created in the second wall, the first and second apertures being coaxially aligned.

11. The assembly of claim 10, further comprising a pin slidably disposed through both the first and second apertures operable to retain the flat portion between the pin and the connecting flange.

12. The assembly of claim 11, further comprising a substantially U-shaped bearing element disposed between the connecting flange and the pin.

13. The assembly of claim 12, wherein the bearing element comprises a polymeric material.

14. The assembly of claim 9, wherein the support arm further comprises a rolled second end.

15. The assembly of claim 9, further comprising a fastener slidably disposed through the rolled first end operable to rotatably connect the rolled first end to a frame member of the golf car.

16. A leaf spring assembly for a golf car, comprising:
a homogenous spring body including:
a rolled first end;
a curving portion extending away from the rolled first end; and
a flat portion defining a second end;
a pin inserted through the rolled first end operable to rotatably connect the rolled first end to a frame member of the golf car; and
a U-shaped bracket connected to the frame member operable to slidably support the flat portion within the bracket;
wherein a vertical deflection of the spring body creates one of a forward and a rearward sliding motion of the flat portion within the bracket.

17. The assembly of claim 16, further comprising a bend portion connecting the curving portion to the flat portion.

18. The assembly of claim 17, wherein the curving portion defines a first concave curving surface.

19. The assembly of claim 18, wherein the bend portion defines a second concave curving portion facing opposite to the first concave curving surface.

20. The assembly of claim 16, wherein the U-shaped bracket further comprises opposed walls joined by a connecting flange.

21. The assembly of claim 16, further comprising a polymeric bearing element connected to the U-shaped bracket positioned to directly engage the flat portion.

22. A golf car, comprising:
a frame;
a suspension system connected to the frame, the suspension system including:
a leaf spring having a rolled first end rotatably pinned to the frame and a second flat end;
a U-shaped bracket connected to the frame having the second flat end of the leaf spring slidably disposed through the U-shaped bracket;
a polymeric bearing element connected to the U-shaped bracket slidably engaged with the flat end; and
a pin inserted through the U-shaped bracket operable to retain the flat end between the opposed walls and the polymeric bearing element.

23. The golf car of claim 22, wherein the polymeric bearing element further comprises a polyamide material.

24. The golf car of claim 22, further comprising opposed walls of the U-shaped bracket joined by a connecting flange.

25. The golf car of claim 22, further comprising an aperture created through each of the opposed walls operable to receive the pin.

26. The golf car of claim 22, wherein the leaf spring further comprises:
a first concave curving surface;
a second concave curving surface proximate to the second flat end, the first concave curving surface facing opposite to the second concave curving surface.

27. The golf car of claim 22, wherein the leaf spring further comprises:
a curving portion extending away from the rolled first end;
a planar section subdividing the curving portion into first and second curved portions; and
a bend portion connecting the second curved portion to the second flat end.

28. A method for creating a suspension system for a golf car, the golf car including a frame, and the suspension system including a leaf spring having a rolled first end and a second flat end and a U-shaped bracket having a polymeric bearing element and a pin, the method comprising:
rotatably pinning the rolled first end to the frame;
extending the second flat end through the U-shaped bracket; and
slidably supporting the second flat end in the U-shaped bracket between the polymeric bearing element and the pin.

29. The method of claim 28, further comprising creating a support arm extending outwardly from the U-shaped bracket.

30. The method of claim 29, further comprising rolling a distal end of the support arm to operably receive a fastener.

31. The method of claim 28, further comprising sliding the fastener through the rolled distal end of the support arm and the frame to rotatably engage the support arm to the frame.

32. The method of claim 28, further comprising forming the leaf spring with a first concavely curving portion and a second concavely curving portion facing opposite to the first concavely curving portion.

33. The method of claim 28, further comprising positioning the second concavely curving portion proximate to the second flat end.
